(19) United States
(12) Patent Application Publication
(10) Pub. No.: US 2018/0152778 A1
(43) Pub. Date: May 31, 2018

(54) COMPOSITE EARPHONE

(71) Applicant: Vencer Co., Ltd., New Taipei City (TW)

(72) Inventors: Jen-Hwa DU, New Taipei City (TW); Ming-Huei WU, New Taipei City (TW)

(21) Appl. No.: 15/630,998

(22) Filed: Jun. 23, 2017

(30) Foreign Application Priority Data
Nov. 30, 2016 (TW) 105218344

(51) Int. Cl. H04R 1/10; H04W 4/00

(52) U.S. Cl. CPC H04R 1/1016; H04R 1/1041; H04R 2420/07; H04R 2201/107; H04W 4/008

(57) ABSTRACT

A composite earphone includes at least one earphone assembly and a transmission-line assembly. The at least one earphone assembly includes a speaker module, a wireless signal transmission module, an adapting device, and a battery module, wherein both the speaker module and the wireless signal transmission module are electrically connected with the battery module. The transmission-line assembly includes at least one signal-output portion, a wire portion, and a signal-input portion. The at least one signal-output portion corresponds to the adapting device of the at least one earphone assembly, and that the wire portion is connected with the at least one signal-output portion and the signal-input portion. Thereby, an earphone user can listen to the music by a way of wireless transmission of audio signals through the wireless signal transmission module or a way of wire transmission audio of audio signals through the transmission-line assembly.

### BACKGROUND OF THE INVENTION

### Field of the Invention

The present invention relates to a composite earphone, and more particularly, to a composite earphone using an adapting device to improve the manner of listening.

### Description of Related Art

When listening to the music, sound playing devices such earphones or audios are employed. Earphones, due to convenience in portability, are often incorporated with smart phones or mini music players, and are thus widely adopted by general consumers.

Upon using the earphones, tangling of the earphone cords around a user's neck always shrinks the convenience of use. Nowadays, through the help of technological progressiveness, the earphones are able to get rid of the conventional cord-connection manner in audio transmission. That is to say, wireless transmission is used, instead, to transmit audio; and as such, users will not be adversely affected in terms of convenience of use, because no more earphone cords are used for earphones. This will facilitate enjoyment of music listening.

However, in view of the fact that wireless earphones consume higher electric power, even a normal use of the earphones will require a frequent charge. This reduces the available period of time in using the wireless earphones, though the convenience of the wireless earphones will no longer be adversely affected by earphone cords.

Given the above, great efforts have been made, through continuous research and experiments, to conceive and eventually accomplish the present invention “A Composite Earphone” having earphone components including an adapting device, so as to improve the convenience in using wireless earphones, such that users can listen to the music at an option on wireless transmission or wire transmission.

### SUMMARY OF THE INVENTION

An object of the present invention is to provide a composite earphone so as to solve the problem as mentioned above, and to achieve the purpose of improving the manner of music listening for earphones.

To achieve the above-mentioned object, the composite earphone, according to the present invention, comprises at least one earphone assembly and a transmission-line assembly. The at least one earphone assembly includes a speaker module, a wireless signal transmission module, an adapting device, and a battery module, wherein both the speaker module and the wireless signal transmission module are electrically connected with the battery module. The transmission-line assembly includes at least one signal-output portion, a wire portion, and a signal-input portion. The at least one signal-output portion corresponds to the adapting device of the at least one earphone assembly, and that the wire portion is connected with the at least one signal-output portion and the signal-input portion.

According to the present invention, the adapting device includes a control switch connected with the wireless signal transmission module. In case the adapting device and the signal-output portion are in a disconnected status, the control switch turns on signals of the wireless signal transmission module; and in case the adapting device and the signal-output portion are in a connected status, the control switch shuts off the signals of the wireless signal transmission module, thus an earphone user can listen to the music by a way of wireless transmission of audio signals or a way of wire transmission of audio signals.

Further, according to the present invention, the at least one earphone assembly can be disposed in a storage box, where the storage box includes at least one first accommodating slot for receiving the at least one earphone assembly correspondingly.

Still further, according to the present invention, the storage box may further include a second accommodating slot for receiving the transmission-line assembly.

According to the present invention, the at least one earphone assembly further includes at least one charging hole electrically connected with the battery module. The storage box may further include at least one power-output portion, a power port, and a circuit board. The at least one charging hole may correspond to the at least one power-output portion, and that the at least one power-output portion may be disposed in the at least one first accommodating slot. The circuit board may be electrically connected with the at least one power-output portion and the power port. Thereby, the battery module inside of the at least one earphone assembly can be charged.

Further, according to the present invention, the storage box may further include a protective casing, which is sleeved to the storage box, for protecting the at least one earphone assembly and the transmission-line assembly.

Still further, according to the present invention, the wireless transmission module may relate to a Bluetooth transmission device.

According to the present invention, the adapting device may relate to a micro-miniature coaxial (MMCX) connector.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view illustrating a composite earphone according to the present invention;

FIG. 2 is a perspective view illustrating the composite earphone and a storage box according to the present invention;

FIG. 3 is another perspective view illustrating the composite earphone and the storage box according to the present invention;

FIG. 4 is still another perspective view illustrating the composite earphone and the storage box according to the present invention; and

FIG. 5 is a block diagram illustrating the construction, in detail, of the composite earphone and the storage box according to the present invention.

### DETAILED DESCRIPTION OF THE PREFERRED EMBODIMENTS

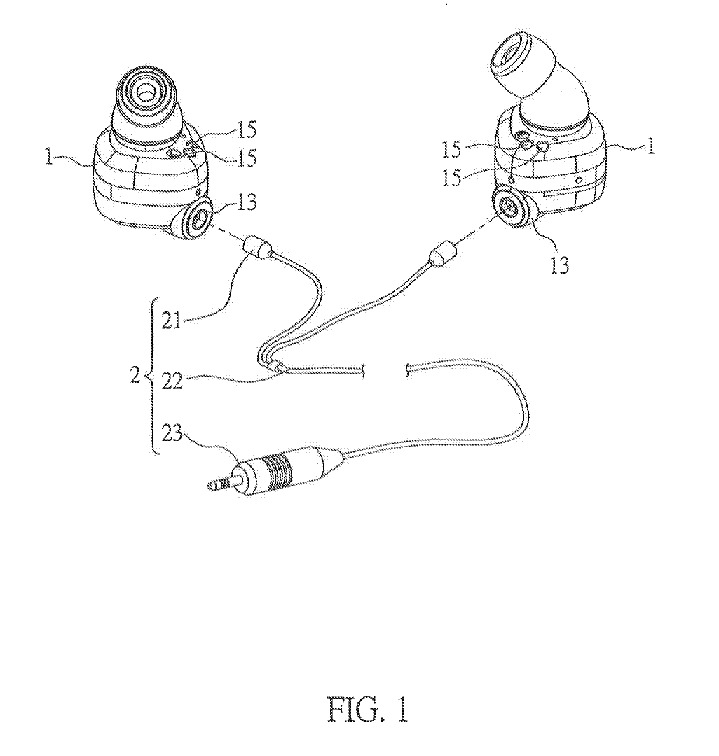

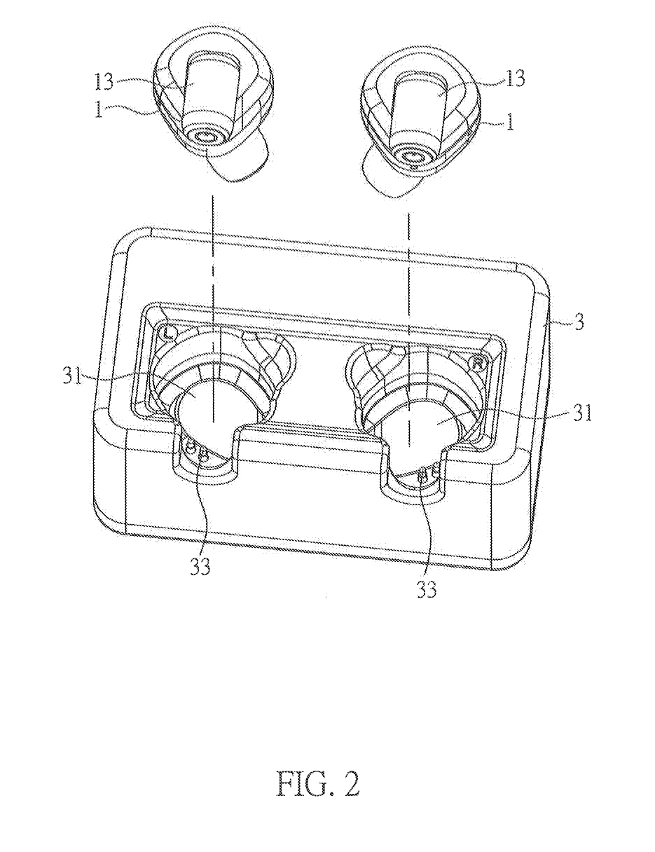

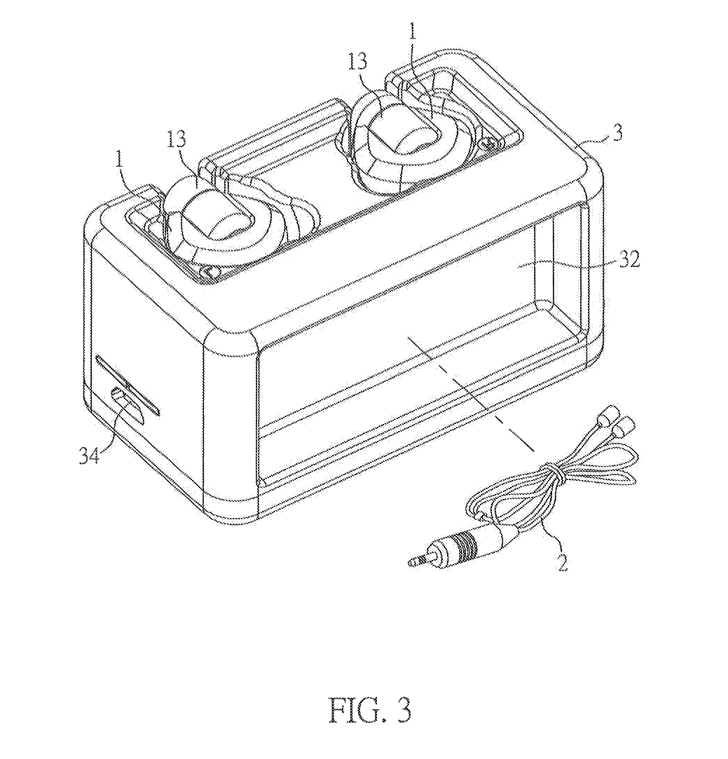

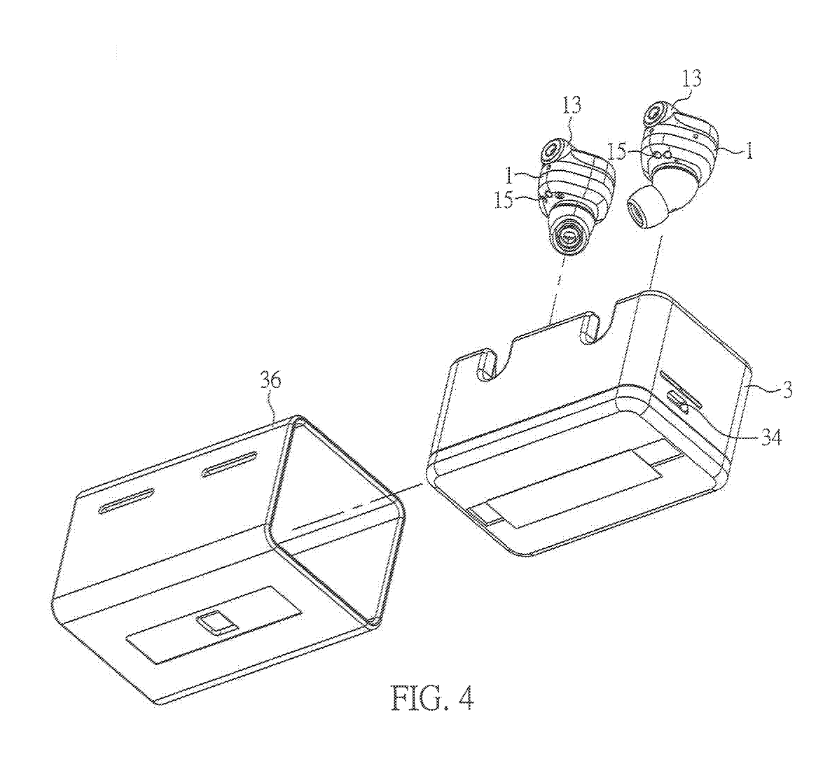

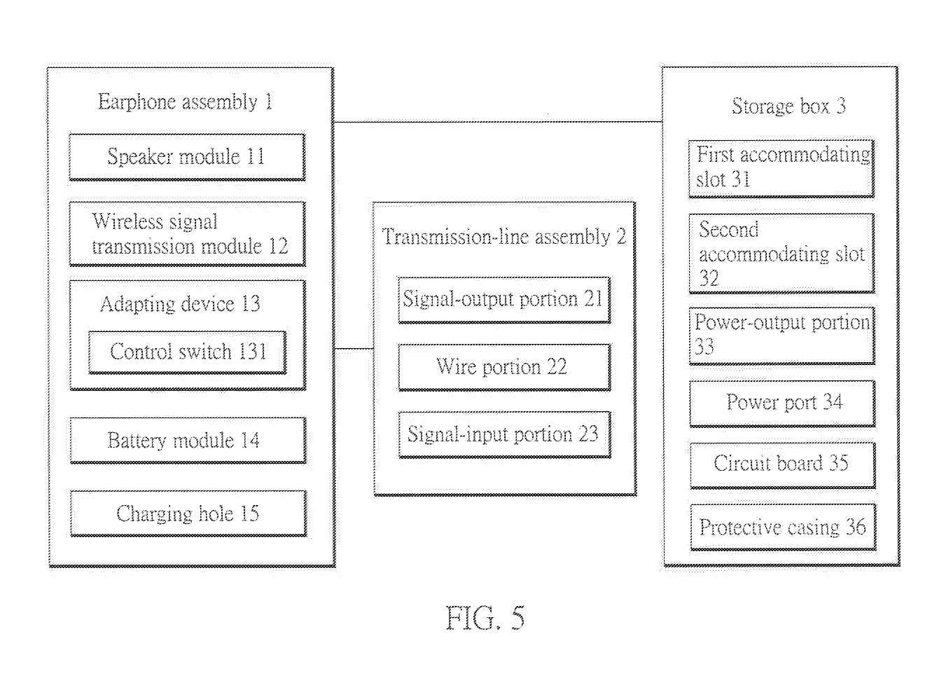

References are made to FIG. 1, a perspective view illustrating a composite earphone according to the present invention; FIG. 2, a perspective view illustrating the composite earphone and a storage box according to the present invention; FIG. 3, another perspective view illustrating the composite earphone and the storage box according to the present invention; FIG. 4, still another perspective view illustrating the composite earphone and the storage box according to the present invention; and FIG. 5, a block diagram illustrating the construction, in detail, of the composite earphone and the storage box according to the present invention.

According to the present invention, the composite earphone comprises two earphone assemblies 1 and a transmission-line assembly 2. The earphone assemblies 1 each include a speaker module 11, a wireless signal transmission module 12, an adapting device 13, a battery module 14, and two charging holes 15. The transmission-line assembly 2 includes two signal-output portions 21, a wire portion 22, and a signal-input portion 23.

Further, according to the present invention, in the earphone assembly 1, the speaker module 11, the wireless signal transmission module 12, and the charging holes 15 are all electrically connected with the battery module 14. The two signal-output portions 21 of the transmission-line assembly 2 each correspond to the adapting device 13 of the earphone assembly 1, respectively. The wire portion 22 is connected with the two signal-output portions 21 and the signal-input portion 23.

The adapting device 13 of the earphone assembly 1 includes a control switch 131, where the control switch 131 is connected with the wireless signal transmission module 12 such that the status of connection between the adapting device 13 and the signal-output portion 21 can be determined. In case the adapting device 13 and the signal-output portion 21 are in a disconnected status, the control switch 131 turns on signals of the wireless signal transmission module 12, thus audio signal is transmitted from the wireless signal transmission module 12 to the speaker module 11. Whereas in case the adapting device 13 and the signal-output portion 21 are in a connected status, the control switch 131 shuts off the signal of the wireless signal transmission module 12, thus audio signal is transmitted from the transmission-line assembly 2 to the speaker module 11. According to the present invention, the adapting device 13 may relate, but not limit, to a micro-miniature coaxial (MMCX) connector, namely any adapting device of the control switch 131 with equivalent functions will be appropriate.

According to the present invention, earphone users can change the way to use the earphone assembly 1 depending on the power status of the battery module 14 of the earphone assembly 1. When the battery module 14 has a sufficient power, the earphone users can use the wireless signal transmission module 12 of the earphone assembly 1 to perform a transmission of audio signal, and listen to the music through the speaker module 11. Whereas suppose the battery module 14 has an insufficient power, the earphone users can use the adapting devices 13 of the earphone assembly 1 to connect with the signal-output portions 21 of the transmission-line assembly 2 to perform a transmission of audio signal in a wiring manner, and listen to the music through the speaker module 11. This will solve the problem of failure to listen to the music for the earphone assembly 1 when the power of the battery module 14 has been consumed.

Further, according to the present invention, the wireless transmission module 12 may relate, but not limit, to a Bluetooth transmission device, namely infrared transmission device or Wi-Fi wireless transmission device, or devices having equivalent functions will be appropriate. In addition, in spite of the fact that, according to the present invention, two earphone assemblies 1 are exemplified, it is obvious that the structural design having a single earphone assembly 1 used for a single ear can also be adopted.

Still further, according to the present invention, the two earphone assemblies 1 and the transmission-line assembly 2 of the composite earphone can be disposed in a storage box 3, where the storage box 3 includes two first accommodating slots 31, a second accommodating slot 32, four power-output portions 33, a power port 34, a circuit board 35, and a protective casing 36.

According to the present invention, the two first accommodating slots 31 correspond to the two earphone assemblies 1, and are provided for receiving the same, respectively; whereas the second accommodating slot 32 for receiving the transmission-line assembly 2. The first accommodating slots 31 are each provided with two power-output portions 33 corresponding to the two charging holes 15 of the earphone assembly 1. The circuit board 35 is electrically connected with each of the power-output portions 33 and with the power port 34. The protective casing 36 can be sleeved to the storage box 3.

Further, according to the present invention, the storage box 3 not only serves to receive the two earphone assemblies 1, but also to charge the battery modules 14 of the earphone assemblies 1. Through electrical connections of the charging holes 15 of the earphone assemblies 1 with the power-output portions 33 of the storage box 3, electrical power of an outside power source can be conveyed, via the power port 34 and the circuit board 35, from the power-output portions 33 to the battery modules 14 so as to achieve the purpose of charging the battery modules 14. This will provide the battery modules 14 a sufficient power to drive the speaker modules 11 and the wireless transmission modules 12.

Still further, the number of the charging holes 15 of the earphone assemblies 1, and of the power-output portions 33 of the storage box 3, is not limited to two. In other words, the number of the charging holes 15 and of the power-output portions 33 can be varied in accordance with actual needs, so long as the charging holes 15 and the power-output portions 33 can be connected correspondingly and that the battery modules 14 can be charged.

Given the above, it is noted that, the composite earphone, according to the present invention, makes use of the design of the adapting device 13 for altering the way of transmission for video signals such that the earphone assembly 1 can satisfy the demand of earphone users. Namely, when the battery module 14 of the earphone assembly 1 has a sufficient power, the wireless signal transmission module 12 of the earphone assembly 1 can be used for listening to the music; whereas suppose the power of the battery module 14 has been consumed, the adapting device 13 of the earphone assembly 1 can be connected with the signal-output portions 21, and the signal-input portion 23 with smartphones or music playing device. As such, convenience of use can be improved for the earphone; namely through the control switch 131, audio signals can be changed into a wire transmission for music listening.

Although the present invention has been explained in relation to its preferred embodiments, it is to be understood that many other possible modifications and variations can be made without departing from the scope of the invention as hereinafter claimed.

1. A composite earphone, comprising:
at least one earphone assembly, including a speaker module, a wireless signal transmission module, an adapting device, at least one charging hole, and a battery module, wherein the speaker module, the wireless signal transmission module and the at least one charging hole are electrically connected with the battery module; and
a transmission-line assembly, including at least one signal-output portion, a wire portion, and a signal-input portion, wherein the at least one signal-output portion corresponds to the adapting device of the at least one earphone assembly, and the wire portion is connected with the at least one signal-output portion and the signal-input portion,
wherein the at least one earphone assembly is disposed in a storage box, and the storage box includes at least one first accommodating slot for receiving the at least one earphone assembly, at least one power-output portion, a power port, and a circuit board, and the at least one charging hole corresponds to the at least one power-output portion, and the at least one power-output portion is disposed in the at least one first accommodating slot, and the circuit board is electrically connected with the at least one power-output portion and the power port.

2. The composite earphone as claimed in claim 1, wherein the adapting device includes a control switch connected with the wireless signal transmission module.

3. The composite earphone as claimed in claim 2, wherein in case the adapting device and the signal-output portion are in a disconnected status, the control switch turns on signals of the wireless signal transmission module.

4. The composite earphone as claimed in claim 2, wherein in case the adapting device and the signal-output portion are in a connected status, the control switch shuts off the signals of the wireless signal transmission module.

5. (canceled)

6. The composite earphone as claimed in claim 1, wherein the storage box further includes a second accommodating slot for receiving the transmission-line assembly.

7. (canceled)

8. The composite earphone as claimed in claim 1, wherein the storage box further includes a protective casing sleeved to the storage box.

9. The composite earphone as claimed in claim 1, wherein the wireless transmission module relates to a Bluetooth transmission device.

10. The composite earphone as claimed in claim 1, wherein the adapting device relates to a micro-miniature coaxial (MMCX) connector.
